(19) United States
(12) Patent Application Publication
(10) Pub. No.: US 2004/0194109 A1
(43) Pub. Date: Sep. 30, 2004

(54) Multi-threaded time processing unit for telecommunication systems

(76) Inventors: Tibor Boros, San Francisco, CA (US); Rabih Chrabieh, San Francisco, CA (US); Doug Dahlby, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/397,689

(22) Filed: Mar. 25, 2003

(51) Int. Cl. G06F 9/00

(52) U.S. Cl. 718/107

(57) ABSTRACT

Embodiments of the invention provide methods and apparatuses to provide concurrent execution of multiple instruction threads for independent control of two or more subsystems of a communication device. One embodiment includes a memory containing a plurality of instruction threads. Each of the plurality of instruction threads contains a timing specification and a corresponding timing reference. An execution unit is coupled to the memory. The execution unit concurrently executes each of the plurality of instruction threads in accordance with the timing specification and the corresponding timing reference of each instruction thread.

### FIELD

Embodiments of the invention relate generally to programmable system controllers and more particularly to system controllers providing real-time system control.

### BACKGROUND

Telecommunications systems typically employ strict standards that require real-time control of the radio and base-band subsystems of the system. Such systems employ a system controller to switch devices (e.g., a receiver, a transmitter, etc.) on and off, change the frequency, or tune the receiver or transmitter gain in real time. This is usually effected through the use of real-time control signals that are generated by a stand-alone system controller commonly referred to as a time processing unit (“TPU”). The TPU is typically implemented as an ASIC or part of an ASIC. The TPU may be programmable to allow flexibility in meeting the requirements of various radio designs. The TPU reads and executes instruction code from a TPU RAM, which is usually configured at system initialization. The instruction code allows the TPU to enable, disable, tune, or program various base-band and radio devices at pre-defined times. The TPU RAM contains a timing sequence (table of timing values) that dictate when particular devices are activated or deactivated (i.e., when instructions are executed). The TPU uses this timing specification in conjunction with a dedicated system timer to effect instructions at the specified times. That is, the TPU reads instructions from the RAM, looks up timing values, and then effects the real-time control signaling according to the specified timing values. Thus the TPU may be used to ensure that a particular instruction is executed when the system timer has reached a pre-defined value.

### Timing Offset

Radio communication systems may have a cellular architecture, with each cell corresponding roughly to a geographical area. Each cell includes a base station (“BS”), which is a local central site through which a number of radio transmitter/receiver units (user terminals (“UT”s)) gain access to the communications system. The UTs could be, for example, telephones, PDAs, or small modem boards. A UT establishes a communication link with other UTs by requesting access to the system through the BS. Each UT communicates over a communication channel distinguished from other UTs. Various techniques exist to increase the number of available channels for a given number of available frequencies. Time division multiple access (“TDMA”), for example, divides a single frequency into multiple time slots. Each of the time slots can then be allocated to a separate communication channel. Time division duplexing (“TDD”) is the application of TDMA to separate downlink and uplink signals.

Typically TDD systems require each device (“UT”) to acquire and maintain a precise system time from an external reference source (“BS”). When the UT is activated, its free-running system timer begins running and the UT is unaware of its internal initial clock rate relative to the external reference source (i.e., the system timer may be running faster or slower than the external reference) and any initial timing offset. Also, during operation the system timer may slowly drift for various reasons (e.g., imperfections or temperature). So the UT periodically acquires the BS timing in order to estimate its timing offset and adjust its system timing. The precise BS timing may be acquired by receiving a broadcast channel (“BCH”) from the BS. When a timing offset is determined, the timing specification for instruction execution contained in the TPU RAM must be shifted accordingly (i.e., either advanced or delayed).

FIG. 1A illustrates the concept of timing offset in the context of a TDD telecommunications system. As shown in FIG. 1A, the BS 105 transmits three downlink frames in a BS transmit window beginning at time T₀. After time T₂ the BS expects to receive an uplink transmission from UT 120 and therefore ceases transmitting. A UT, expecting to receive the downlink frames and running its own system clock, turns on its receiver at the expected time. If the UT has been idle, its system clock may have drifted. This is timing offset and may cause the UT to turn on its receiver at the wrong time.

As shown in FIG. 1A, the UT 120 anticipates system clock drift and applies a search window 121 of, for example, ±4 microseconds around the expected receive time T₀. That is, the UT 120 turns on its receiver 4 microseconds prior to the expected receive time T₀, and continues to search for the downlink burst throughout an 8-microsecond search window. Therefore, when the UT 120 receives the downlink frames at time T₁, 2 microseconds late, the UT 120 estimates that its system clock has drifted 2 microseconds from the BS reference. The 2 microsecond timing offset extends the receive window of the UT 120 by 2 microseconds to time T₃ and consequently also affects the transmit window of UT 120.

To maintain frame synchronization in a TDD system, the problem of timing offset is addressed through use of a timing offset register (“TOR”). Every time a signal is received, the UT microprocessor or micro-controller estimates a timing offset and writes a value to the TOR according to the estimated timing offset. The TOR value is then added to the system timer value and the sum is used as the time reference of the TPU. This shifts the entire system clock reference of the UT and has the effect of adjusting (advancing or delaying) all system control signals simultaneously.

### Timing Advance

The use of a TOR allows all of the system control signals to be adjusted, but not relative to one another. That is, the TOR does not allow the transmit control signals to be adjusted with different values than the receive control signals. This is problematic for TDD telecommunications systems in which the same frequency is used for receiving and transmitting, and compensation must be made for the propagation time between the BS and the UT. As shown in FIG. 1B, depending on the distance between the BS and the UT, the UT receives the downlink frames after a propagation delay time T_{P}. The UT begins its uplink transmission with the delay of time T_{P} and, due to the uplink propagation delay, the BS receives the uplink frames with a delay of 2 T_{P}. Because each of the UTs communicating through the BS have a different geographic location and hence a different propagation delay time, it is not practical to adjust the BS frame reference in an attempt to compensate for propagation delay. Instead the BS establishes an uplink receive window and requests each UT to begin uplink transmission so that the uplink frames arrive within the uplink receive window. That is, the BS will, periodically (e.g., every 1000 frames) check the uplink timing and, if necessary, request the UT to advance its transmitter timing. This is timing advance.

FIG. 1B illustrates the concept of timing advance in the context of a TDD telecommunications system. As shown in FIG. 1B, the BS 150 transmits three downlink frames at time T₀. The UT 160 begins receiving the downlink frames after a propagation delay of T_{P} precisely at the expected time T₁ (i.e., with no timing offset). The UT 160 completes reception at time T₃, waits until time T₆ and, without timing advance, begins transmitting three uplink frames. The BS expects the uplink frames at time T₅, but due to the propagation delay, does not begin receiving the uplink frames until time T₇ (i.e., T₅ plus 2 T_{P}). In contrast, UT 170, upon request from the BS, will advance its transmitter timing by 2 T_{P} (i.e., from time T₆ to time T₄) to compensate for the downlink and uplink propagation delay. With timing advance, the BS will receive the uplink frames at the expected time T₅ (i.e., within the uplink receive window).

To implement timing advance while maintaining frame synchronization requires adjusting the transmitter timing without affecting the receiver timing. That is, independent control of transmitter timing is desired. This involves a burdensome amount of additional processing to suspend the TPU operation and reconfigure the timing specification.

### SUMMARY

Embodiments of the invention provide methods and apparatuses to provide concurrent execution of multiple instruction threads for independent control of two or more subsystems of a communication device. One embodiment includes a memory containing a plurality of instruction threads. Each of the plurality of instruction threads has a corresponding time specification and a corresponding timing reference. An execution unit is coupled to the memory. The execution unit concurrently executes each of the plurality of instruction threads in accordance with the corresponding timing specification and the corresponding timing reference of each instruction thread.

Other features and advantages of embodiments of the present invention will be apparent from the accompanying drawings and from the detailed description that follow below.

### BRIEF DESCRIPTION OF THE DRAWINGS

The invention may be best understood by referring to the following description and accompanying drawings that are used to illustrate embodiments of the invention. In the drawings:

FIG. 1A illustrates the concept of timing offset in the context of a TDD telecommunications system;

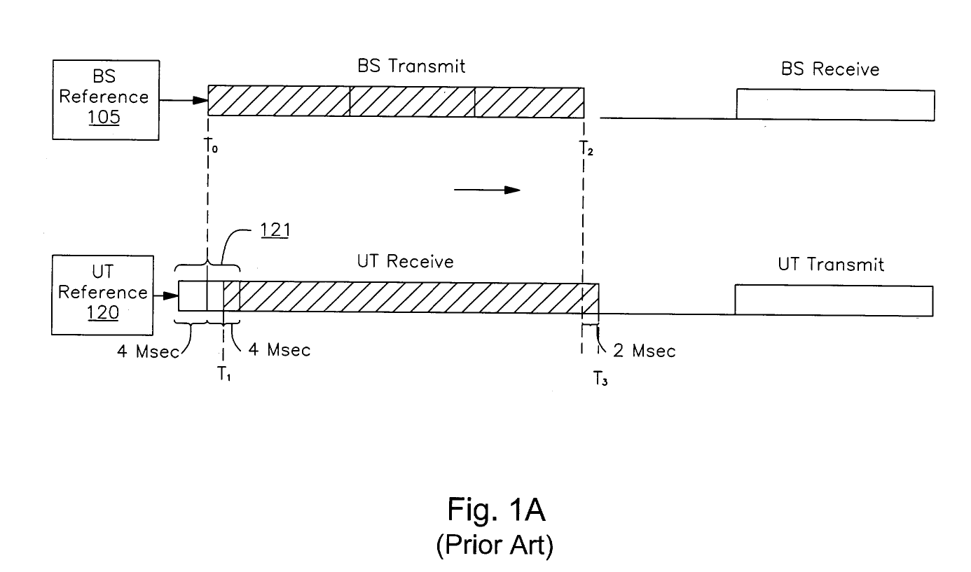

FIG. 1B illustrates the concept of timing advance in the context of a TDD telecommunications system;

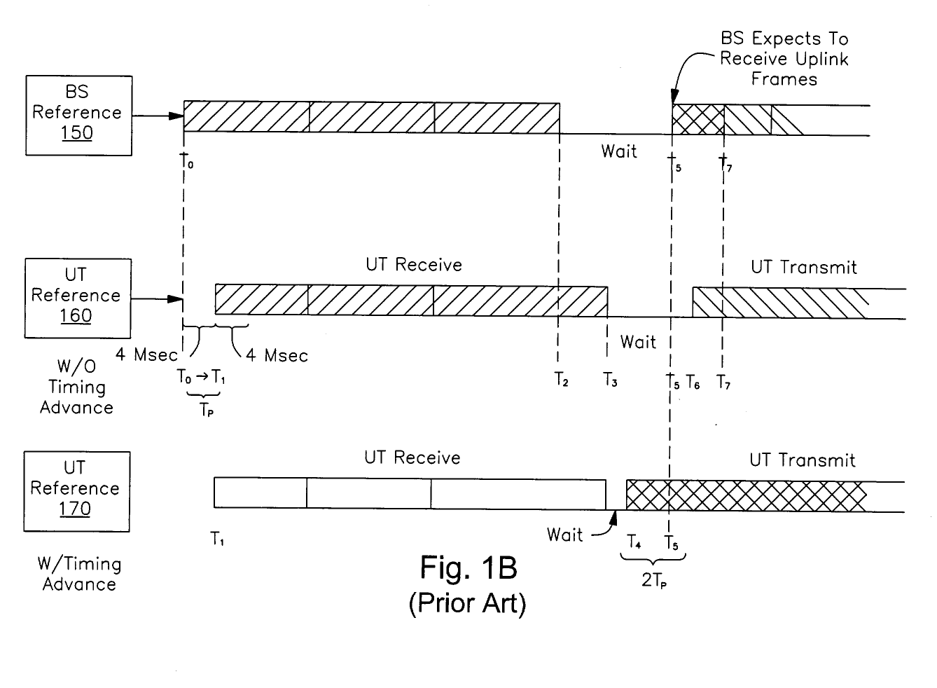

FIG. 2 illustrates a process by which a multithreaded TPU (“MTTPU”) is employed to concurrently provide independent real-time control of two or more subsystems in accordance with one embodiment of the invention;

FIG. 3 illustrates the system architecture of an MTTPU in accordance with one embodiment of the invention; and

FIG. 4 illustrates a baseband processing system for a UT that implements a MTTPU in accordance with one embodiment of the invention

### DETAILED DESCRIPTION

### Overview

Embodiments of the invention provide a multithreaded, programmable system controller MTTPU that allows concurrent execution of multiple instruction threads for independent control of two or more subsystems. The multiple instruction threads have distinct timing specifications and distinct timing references. For one embodiment, the distinct timing references are comprised from the combination of a common timing reference and distinct timing offsets.

For one embodiment, the MTTPU generates control signals independently for multiple subsystems of a TDD telecommunications system. For such an embodiment, the MTTPU allows independent control of the receiver and transmitter. Providing a separate TOR for each instruction thread allows the system to maintain a timing offset for the transmitter that is independent of the timing offset for the receiver to maintain frame synchronization. Thus, the MTTPU allows the UT to effect timing advance (adjust transmit timing and receive timing using different values) without suspending TPU operation.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

### Process

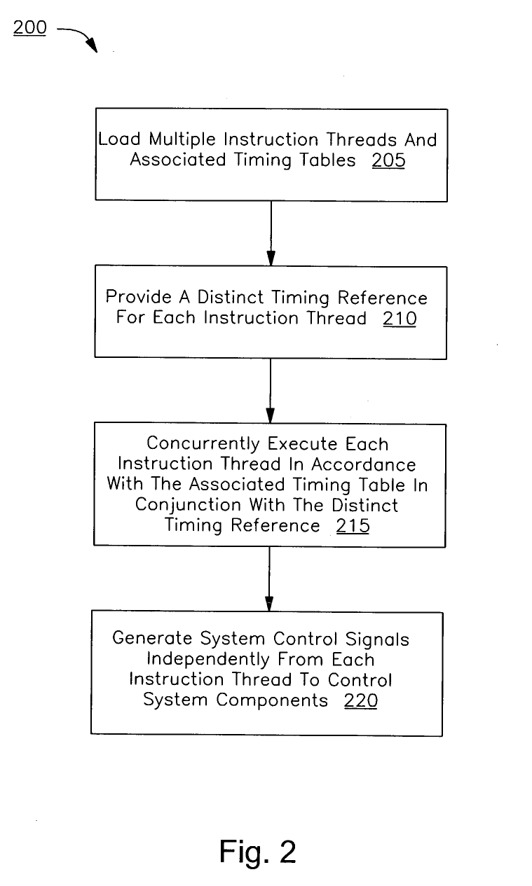

FIG. 2 illustrates a process by which an MTTPU is employed to concurrently provide independent real-time control of two or more subsystems in accordance with one embodiment of the invention. Process 200, shown in FIG. 2, begins with operation 205 in which an MTTPU code is provided. The MTTPU code contains multiple instruction threads each containing a timing specification (e.g., a timing table) that specifies execution times for some instructions of the instruction thread. Each instruction thread pertains to the control of a separate subsystem. As described below, the MTTPU code may be loaded into an internal system memory by a system microcontroller (“MCU”).

At operation 210 a separate timing reference is provided for each instruction thread. As described below, the timing reference for each thread may be a combination of a common timing reference with a timing offset particular to a given instruction thread.

At operation 215 each of the multiple instruction threads are executed concurrently in accordance with the timing specification contained in the instruction thread in conjunction with the timing reference for the instruction thread. For one embodiment, an instruction execution unit (“IEU”) accesses a timing reference for an instruction thread and begins executing the instruction thread in accordance with its timing specification. While the instruction thread is being executed, the process of accessing a timing reference for an instruction thread and executing the instruction thread in accordance with its timing specification is repeated for additional instruction threads.

At operation 220 the execution of each instruction thread generates system control signals to independently control a particular subsystem. For example, the execution of one instruction thread may control the receiver section of a TDD telecommunications system, while another instruction thread may control the transmitter section of the TDD telecommunications system. Because each instruction thread has its own timing reference, the system MCU, or other external entity, can independently adjust the timing reference of each instruction thread to delay or advance all instructions that control a particular subsystem without affecting the timing for instruction sequences that control other subsystems. Thus, an embodiment of the invention allows the UT to effect timing advance without suspending operation and performing overly burdensome processing.

### System Architecture

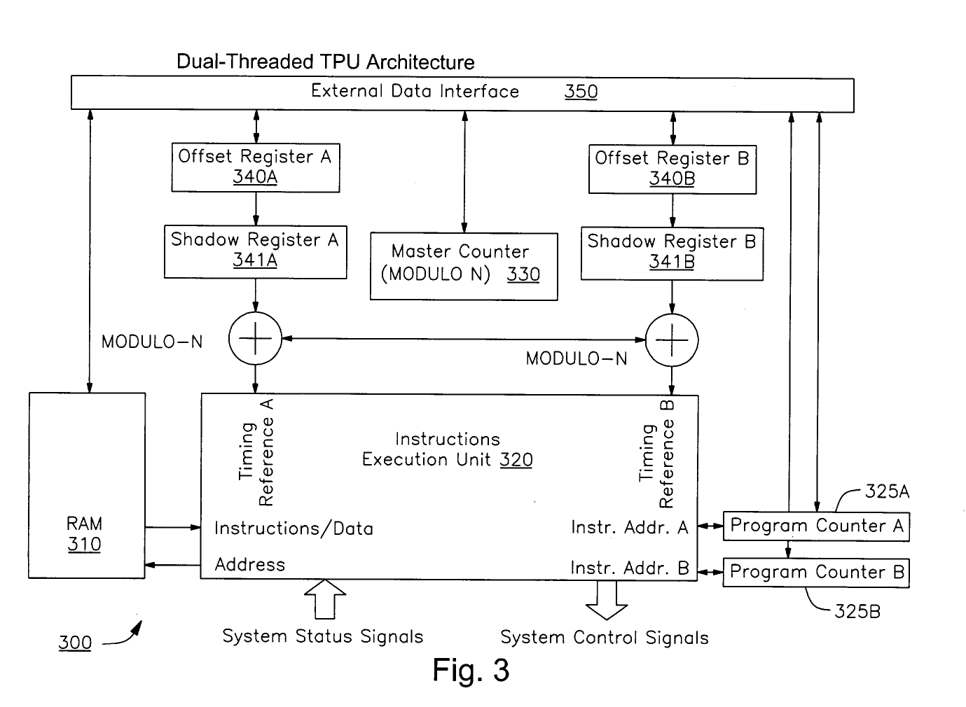

FIG. 3 illustrates the system architecture of MTTPU in accordance with one embodiment of the invention. Though shown in FIG. 3 as a dual-threaded TPU, the MTTPU of the invention is not limited to two instruction threads.

MTTPU 300, shown in FIG. 3, includes an internal memory shown as RAM 310. RAM 310 may be connected to an external entity (e.g., a microcontroller, a microprocessor, a DSP, etc.), not shown, that loads MTTPU code into the RAM 310 at boot-up. An external data interface (“EDI”) 350 allows the MCU access to the RAM 310 to load the MTTPU code. The MTTPU code includes subsystem-specific instructions containing a timing specification (e.g., a timing table associated with the instructions). A set of instructions generates system control signals or sampling functions, such as sampling the system status or sampling the system control signals. The RAM is programmable allowing the timing specifications to be changed at boot up. This provides flexibility to deal with unknown or varying radio specifications.

The RAM 310 is coupled to an instruction execution unit (“IEU”) 320 that fetches and executes instructions from the RAM 310. The IEU 320 fetches instructions for each instruction thread from an address in RAM 310 supplied by a dedicated program counter for the particular instruction thread. The IEU 320 will fetch and execute an instruction for a particular instruction thread from an address (e.g., address 0) as directed by the program counter for the particular instruction thread. The instruction may say, for example, wait until the timing reference reaches 500 and then set an output signal (e.g., a system control signal to enable the transmitter). Concurrently the IEU 320 independently executes another instruction thread by obtaining another instruction from an address (e.g., address 100) as directed by the program counter for that instruction thread. The instruction may say, for example, wait until the timing reference reaches 300 and then set an output signal (e.g., a system control signal to disable the receiver). As shown in FIG. 3, a dedicated program counter, namely program counter 325A and 325B is implemented for each instruction thread. In a typical single threaded system, the reset value of the program counter is zero. As opposed to this, a multithread system requires a separate memory location entry point for each thread, that is, each program counter must have a distinct reset value. The EDI 350 allows the MCU, or other external entities, to READ from the program counter to determine the instruction currently being executed, or to reset the program counter.

In accordance with one embodiment, each instruction thread executes a separate instruction sequence according to a specific timing reference for the particular thread. The timing reference for each thread is provided by combining the value of a system timer with the value of the dedicated TOR for the particular thread. For one embodiment, a system timer (master counter) 330 provides a common time reference for all threads, thus avoiding the necessity to maintain synchronization between separate master counters. For one embodiment, master counter 330 is implemented as a modulo-N counter, where N is chosen to match the length of a standard telecommunication frame. For example, the master counter may be configured to count from 0-500. This coincides with the length of the communication frame. The IEU 320 will handle all of the slots of the frame and then move on to the next frame.

A dedicated TOR, shown as TOR 340A and TOR 340B, is implemented for each thread. The TOR for each thread contains the timing offset value specific to each thread. The EDI 350 allows the MCU, or other external entities, to READ from or WRITE to the TOR in order to adjust timing offset.

For one embodiment, shadow TORs, shown as shadow TORs 341A and 341B, are implemented for each TOR to provide double buffering of the timing offset values for each instruction thread. A shadow TOR may be implemented for systems that require timing offset adjustments to be effected periodically at specified times. For example, some telecommunications standards permit delaying or advancing a transmit burst within a specified window, but the transmit burst length cannot be varied. This means that the timing offset value can be changed between transmissions, but it must remain the same during transmissions. Using a shadow TOR, the MCU may WRITE a new timing offset value to the TOR at any time. The new timing offset value is then used to update the shadow TOR within the specified window for timing offset adjustment (i.e., at an allowed time). An adjusted timing offset for the instruction thread is then provided by adding the shadow TOR content to the master counter value modulo N.

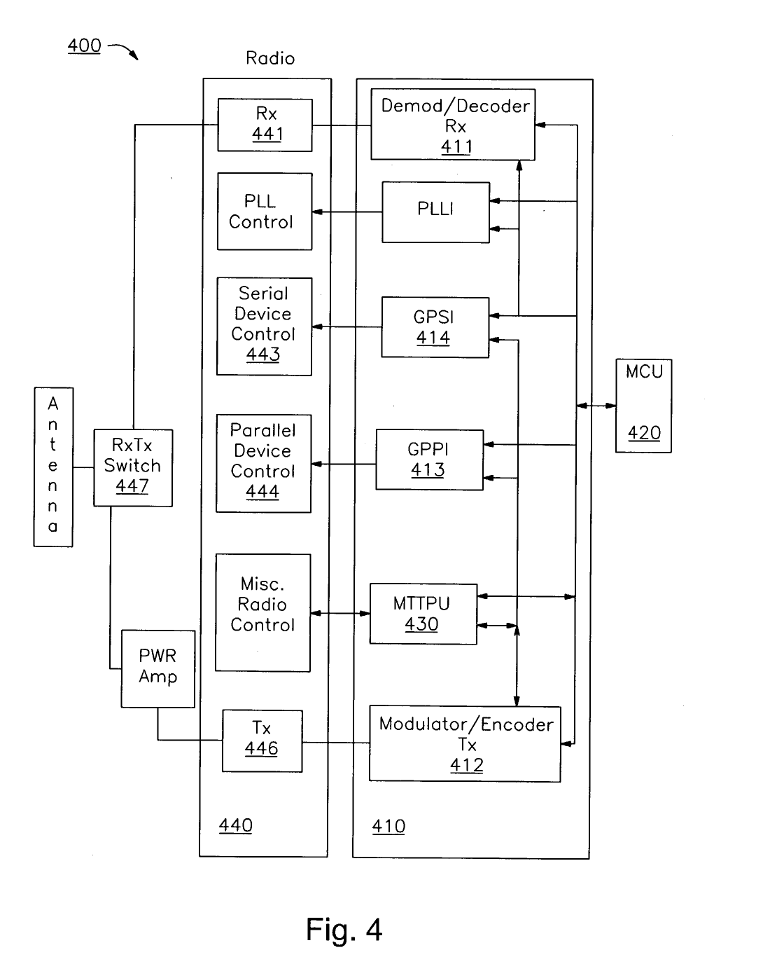

FIG. 4 illustrates a baseband processing system for a UT that implements a MTTPU in accordance with one embodiment of the invention. System 400, shown in FIG. 4, includes an ASIC 410 and an MCU 420. The MCU 420 initially loads the MTTPU code into MTTPU 430. The MTTPU code establishes the sequence of how each subsystem will be controlled. As described above, the MTTPU generates control signals to control various external and internal subsystems. For one embodiment, the MTTPU has a 16-bit output register that is used to enable or disable subsystems in real time. Many of the radio subsystems are amenable to such control. For example, the MTTPU can generate control signals for various subsystems located on radio 440, including radio receiver 441 and radio transmitter 446; and can generate control signals for various internal subsystems including demodulator/decoder 411 and modulator/encoder 412.

Other subsystems require more than a simple enable/disable bit to provide the desired control. For one embodiment, the ASIC 410 includes a general-purpose parallel interface (“GPPI”) 413, which the MTTPU 430 can signal to produce a multi-bit control word to provide control for a parallel device 444 on radio 440 (e.g., tune a reference clock generator at a given time). Alternatively, or additionally, the ASIC 410 may include a general-purpose serial interface (“GPSI”) 414, which the MTTPU 430 can signal to produce a serial sequence to control a serial device 443 on radio 440 (e.g., change an amplifier gain at a given time).

For one embodiment, any of the multiple instruction threads can control the same subsystems through the MTTPU output register. The MTTPU generates a set of control signals that can be used by any instruction thread to enable or disable any subsystem. For example, as shown in FIG. 4, the receiver/transmitter switch 447 may need to be controlled by the instruction thread that controls the receiver 441 or by the instruction thread that controls the transmitter 446. In an alternative embodiment, each instruction thread may control subsystems through separate output registers.

### General Matters

Embodiments of the invention may be applied to provide independent real-time control of multiple subsystems. In accordance with alternative embodiments of the invention, the MTTPU may be implemented in various ways.

The MTTPU includes a programmable internal memory that may be RAM, but which, in alternative embodiments, may be any suitable memory such as ROM, EPROM, flash memory, etc. Such memory still provides increased flexibility over prior art, hard coded, TPU schemes. In an alternative embodiment, the MTTPU may be implemented with a separate internal memory for each instruction thread.

Depending upon system processing speed and system instruction execution rate, a single IEU may be implemented to concurrently execute multiple instruction threads as described above in reference to FIG. 3. For example, a system that has an instruction execution rate of 6 MHz and a processing speed of 48 MHz can concurrently execute eight instruction threads. That is, the system provides eight processor clock signals for every instruction executed. Alternatively, for systems having higher instruction execution rates relative to processing speed, parallel IEUs may be implemented with each IEU executing a subset of the multiple instruction threads.

The MTTPU also includes separate program counters for each instruction thread with each program counter having a distinct reset value that indicates a memory location entry point to the corresponding instruction thread. For one embodiment, the memory location entry point addresses may be arbitrary, with each memory location entry point containing a jump instruction. The jump instruction directs the IEU to the MTTPU code pertaining to the particular instruction thread. This allows the instructions for each instruction thread to be located anywhere in the memory.

Embodiments have been herein described in reference to a TDD system, but the invention is not limited to such systems and may be applied to other systems, for example, a frequency division duplex (“FDD”) system. FDD systems use distinct frequencies for transmission and reception and, therefore, such systems typically require that the transmitter timing and receiver timing be controlled independently. It is important to note that, while the invention has been described in the context of a cellular radio communication system, it can be applied to a wide variety of different systems in which independent real-time control of subsystems is desired. Such systems include voice, video, music, broadcast and other types of data systems without external connections.

Embodiments of the invention include various operations. Many of the methods are described in their most basic form, but operations can be added to or deleted from any of the methods without departing from the basic scope of the invention.

It will be apparent to those skilled in the art that the operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A time processing unit for a communication device comprising:
one or more memory devices containing a plurality of instruction threads, wherein each instruction thread contains a timing specification, each instruction thread having a corresponding timing reference; and
one or more instruction execution units, coupled to the one or more memory devices, to concurrently execute each of the plurality of instruction threads in accordance with the corresponding timing reference of each instruction thread, such that the execution of each of the plurality of instruction threads generates control signals at specified times independently for a corresponding subsystem of the communication device.

2. The time processing unit of claim 1 wherein each time reference corresponding to an instruction thread is obtained by combining a common time reference with a timing offset specific to each instruction thread.

3. The time processing unit of claim 2 wherein each timing offset is stored in a separate timing offset register.

4. The time processing unit of claim 2 further comprising:
an external data interface coupling an external entity to the time processing unit to allow the external entity to communicate with the time processing unit.

5. The time processing unit of claim 4 wherein the external data interface is coupled to each separate timing offset register such that each timing offset can be adjusted independently by the external device.

6. The time processing unit of claim 4 wherein the one or more memory devices are coupled to the external data interface such that the plurality of instruction threads and the timing specifications can be loaded into the one or more memory devices.

7. The time processing unit of claim 3 further comprising a plurality of shadow timing offset registers, each shadow timing offset register corresponding to a timing offset register such that the timing offset of each timing offset register is buffered in the corresponding shadow timing offset register.

8. The time processing unit of claim 7 wherein each instruction thread contains a dedicated instruction such that execution of the dedicated instruction causes the timing offset of the corresponding timing offset register to be buffered in the corresponding shadow timing offset register.

9. The time processing unit of claim 1 wherein each of the plurality of instruction threads has a corresponding program counter coupled to one of the one or more instruction execution units such that the one instruction execution unit obtains an address for each instruction of an instruction thread from the corresponding program counter.

10. The time processing unit of claim 9 wherein each program counter has a distinct reset value, each reset value indicating a memory location entry point to the corresponding instruction thread.

11. The time processing unit of claim 10 wherein each distinct memory location entry point contains a jump instruction to direct the one instruction execution unit to a specified memory location containing the instruction thread corresponding to the program counter.

12. The time processing unit of claim 1 wherein the communication device is a user terminal of a telecommunications system and the plurality of corresponding subsystems of the device include a user terminal receiver and a user terminal transmitter.

13. The time processing unit of claim 12 wherein the telecommunications system is a time division duplex telecommunications system.

14. The time processing unit of claim 13 wherein the timing offset of the instruction thread corresponding to the user terminal transmitter and the timing offset of the instruction thread corresponding to the user terminal receiver are adjusted by different values, thereby effecting a transmission timing advance.

15. A method comprising:
generating a first set of control signals to control a first subsystem of a system, the first set of control signals generated in accordance with a time specification corresponding to the first subsystem and a time reference corresponding to the first subsystem; and
concurrently generating a second set of control signals to control a second subsystem of the communication device, the second set of control signals generated in accordance with a time specification corresponding to the second subsystem and a time reference corresponding to the second subsystem.

16. The method of claim 15 wherein generating a first set of control signals and concurrently generating a second set of control signals includes executing a first instruction thread and concurrently executing a second instruction thread, the first instruction thread containing the time specification corresponding to the first subsystem and the second instruction thread containing the time specification corresponding to the second subsystem.

17. The method of claim 16 wherein the time reference corresponding to the first subsystem is a combination of a common time reference and a timing offset determined for the first subsystem, and the time reference corresponding to the second subsystem is a combination of the common time reference and a timing offset determined for the second subsystem.

18. The method of claim 17 further comprising the antecedent operations of:
storing the first instruction thread and the second instruction thread to a memory device; and
storing an initial timing offset determined for the first subsystem to a first timing offset register, and storing an initial timing offset determined for the second subsystem to a second timing offset register.

19. The method of claim 18 wherein the operations of storing are performed by an external entity through an external data interface coupling the memory device, the first timing offset register and the second timing offset register to the microcontroller.

20. The method of claim 15 wherein the system is a communication device having a transmitter and a receiver.

21. The method of claim 17 further comprising:
adjusting the timing offset determined for the transmitter and adjusting the timing offset for the receiver using different values to effect a transmission timing advance.

22. A machine-readable medium having one or more executable instructions stored thereon, which, when executed by a digital processing system, causes the digital processing system to perform a method, the method comprising:
providing a plurality of instruction threads, each instruction thread containing a timing specification;
providing a plurality of distinct timing references, each timing reference corresponding to one of the plurality of instruction threads; and
concurrently executing each instruction thread in accordance with the corresponding timing reference such that the execution of each of the plurality of instruction threads generates control signals independently, at specified times, for a corresponding subsystem of a communication device.

23. The machine-readable medium of claim 22 wherein an external entity loads the plurality of instruction threads to a memory device via an external data interface, the external data interface coupled to the external entity and to the memory device.

24. The machine-readable medium of claim 22 wherein each time reference corresponding to an instruction thread is a combination of a common time reference with a timing offset specific to each instruction thread.

25. The machine-readable medium of claim 24 wherein each timing offset is stored in a separate timing offset register such that each timing offset can be independently modified by the external entity via the external device interface.

26. The machine-readable medium of claim 23 wherein the memory device comprises random access memory.

27. The machine-readable memory of claim 25 wherein a modification to a timing offset of an instruction thread is stored in a corresponding shadow timing offset register such that the timing offset of each timing offset register is buffered in the corresponding shadow timing offset register.

28. The machine-readable medium of claim 27 wherein each instruction thread contains a dedicated instruction such that execution of the dedicated instruction causes the timing offset of the corresponding timing offset register to be buffered in the corresponding shadow timing offset register.

29. The machine-readable medium of claim 28 wherein each of the plurality of instruction threads has a corresponding program counter to provide an address for each instruction of an instruction thread from the corresponding program counter.

30. The machine-readable medium of claim 29 wherein each program counter has a distinct reset value, each reset value indicating a memory location entry point to the corresponding instruction thread.

31. The machine-readable medium of claim 30 wherein each distinct memory location entry point contains a jump instruction to a specified memory location containing the instruction thread corresponding to the program counter.

32. The machine-readable medium of claim 22 wherein the communication device is a user terminal of a telecommunications system and the plurality of corresponding subsystems of the device include the user terminal receiver and the user terminal transmitter.

33. The machine-readable medium of claim 32 wherein the telecommunications system is a time division duplex telecommunications system.

34. The machine-readable medium of claim 33 wherein the timing offset of the instruction thread corresponding to the user terminal transmitter and the timing offset of the instruction thread corresponding to the user terminal receiver are adjusted by different values, thereby effecting a transmission timing advance.

35. A portion of a cellular radio communications network comprising:
a base station;
a plurality of user terminals communicating through the base station, each user terminal having a plurality of independently controlled subsystems, each of the subsystems controlled through control signals concurrently generated by execution of a corresponding instruction thread containing a timing specification, wherein each instruction thread has a corresponding timing reference.

36. The portion of a cellular communications network of claim 35 wherein the communication network is a time division duplex telecommunications network and the plurality of independently controlled subsystems includes a user terminal receiver and a user terminal transmitter.

37. The portion of a cellular communications network of claim 36 wherein each time reference corresponding to an instruction thread is obtained by combining a common time reference with a timing offset specific to each instruction thread.

38. The portion of a cellular communications network of claim 37 wherein each timing offset is stored in a separate timing offset register.

39. The portion of a cellular communications network of claim 36 further comprising:
an external data interface coupled to each separate timing offset register such that each timing offset can be adjusted independently by an external device.

40. The portion of a cellular communications network of claim 39 wherein the one or more memory devices comprise random access memory coupled to the external data interface such that the plurality of instruction threads, corresponding timing sequences and corresponding timing references can be loaded into the one or more memory devices.

41. The portion of a cellular communications network of claim 39 further comprising a plurality of shadow timing offset registers, each shadow timing offset register corresponding to a timing offset register such that the timing offset of each timing offset register is buffered in the corresponding shadow timing offset register.

42. The portion of a cellular communications network of claim 41 wherein each instruction thread contains a dedicated instruction such that execution of the dedicated instruction causes the timing offset of the corresponding timing offset register to be buffered in the corresponding shadow timing offset register.

43. The portion of a cellular communications network of claim 36 wherein each of the plurality of instruction threads has a corresponding program counter coupled to one of the one or more instruction execution units such that the one instruction execution unit obtains an address for each instruction of an instruction thread from the corresponding program counter.

44. The portion of a cellular communications network of claim 39 wherein each program counter has a distinct reset value, each reset value indicating a memory location entry point to the corresponding instruction thread.

45. The portion of a cellular communications network of claim 44 wherein each distinct memory location entry point contains a jump instruction to direct the one instruction execution unit to a specified memory location containing the instruction thread corresponding to the program counter.

46. The portion of a cellular communications network of claim 37 wherein the timing offset of the instruction thread corresponding to the user terminal transmitter and the timing offset of the instruction thread corresponding to the user terminal receiver are adjusted by different values, effecting a transmission timing advance thereby.
